(19) United States
(12) Patent Application Publication
(10) Pub. No.: US 2025/0390182 A1
(43) Pub. Date: Dec. 25, 2025

(54) MANAGING SINGLE INPUT CONTROL ON VIRTUAL EXTENDED DISPLAYS OF A PARTIALLY FOLDED FIRST DEVICE AND A CONNECTED SECOND DEVICE

(71) Applicant: MOTOROLA MOBILITY LLC, WILMINGTON, DE (US)

(72) Inventors: AMIT KUMAR AGRAWAL, BANGALORE (IN); OLIVIER D MEIRHAEGHE, LINCOLNSHIRE, IL (US)

(21) Appl. No.: 18/747,756

(22) Filed: Jun. 19, 2024

(51) Int. Cl. G06F 3/0362; G06F 3/01

(52) U.S. Cl. CPC G06F 3/0362; G06F 3/012

(57) ABSTRACT

An electronic device, a method, and a computer program product provide for single user pointer control across a partially unfolded display of the electronic device and a display of a second electronic device. A first portion of a folding display is aligned with the display of second electronic device with a second portion of the folding display is not aligned and is positioned on a support surface. The electronic device connects, via a communications subsystem, to a second electronic device having a display. The electronic device presents a first logical display portion on a first portion of the folding display and a second logical display portion on a second portion of the folding display. In response at least in part on the first housing being in an angled position to the second housing, the electronic device presents the second logical display portion on the display of the second electronic device.

### BACKGROUND

### 1. Technical Field

The present disclosure relates generally to mobile electronic devices having a display, and more particularly to foldable mobile electronic devices having display(s) incorporated on each inner side of a foldable housing.

### 2. Description of the Related Art

As technology has advanced, uses for electronic devices have expanded. One such use is small mobile devices, such as smartphones, which have become increasingly powerful despite their small size. For additional portability, some mobile devices have a foldable housing. These mobile devices provide a great deal of portable processing power but the small size for portability limits display size and on-device input controls. Often a larger display of a second electronic device such as a laptop or desktop workstation with larger displays are used to present/mirror the content of the mobile device display when handheld portability is not required, but a larger display and/or user interface (e.g., keyboard and mouse) is needed. With some unique capabilities present on each of the mobile device and the second electronic device, a user will often position both devices closely together to be able to easily look at either display. To make the use of the two adjacent devices more convenient, recent technological advances enable “instant control” that links user interface controls for connected devices. A user input device of one device is able to interact across user interfaces presented on respective displays of the dual devices. Using the instant controls is similar to having dual monitors for one device but provides an ability to interact with the different applications supported by each device. The cooperative user interface controls of instant control can be used even when the dual devices use different operating systems.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 presents a simplified functional block diagram of a foldable communication device in a partially unfolded position and in which the features of the present disclosure are advantageously implemented for single control input in cooperation with connected external display devices, according to one or more embodiments;

FIG. 2 illustrates a back view of the communication device having a foldable housing in a fully unfolded position, according to one or more embodiments;

FIG. 3 illustrates a three-dimensional view of the communication device having a partially unfolded foldable housing placed on a support surface, according to one or more embodiments;

FIG. 4 illustrates a side view of the communication device in a fully folded, more compact form for portability and stowage.

FIG. 5 illustrates a three-dimensional view of the communication device in a partially unfolded, angled position placed on a support surface with a second portion of the extended housing and embedded display in partial alignment with a display of a second electronic device, where instant control pointing to a lower portion of a folding display of the communication device flips presented content from the lower portion to an upper portion, according to one or more embodiments;

FIG. 6 illustrates a front view of the communication environment of the communication device presenting content from two applications with hidden or flattened content in a lower portion of a folding display duplicated on the display of the second electronic device, according to one or more embodiments;

FIG. 7 illustrates the front view of the communications environment of FIG. 6 with an instant control track moving a cursor onto the second portion of the folding display that the user is not positioned to view, according to one or more embodiments;

FIG. 8 illustrates the front view of the communications environment of FIG. 7 with the communication device swapping the first and the second logical display portions in response to the instant control track moving the cursor onto the second portion of the folding display, according to one or more embodiments;

FIG. 9 illustrates a front view of the communication environment of the communication device presenting content from one first application such as a camera application with duplication of hidden or flattened content duplicated on the display of the second electronic device, according to one or more embodiments;

FIG. 10 is a flow diagram presenting a method of providing single input control across displays of connected devices that mitigates having a portion of one display of a partially unfolded device being aligned and another portion being unaligned, according to one or more embodiments; and

FIG. 11 is a flow diagram presenting a method, augmenting the method of FIG. 10, for special use cases of assigning particular portions of a logical display of the first electronic device to displays of the connected second electronic devices.

### DETAILED DESCRIPTION

According to aspects of the present disclosure, a first electronic device, a method, and a computer program product provide a cooperative user interface connection between the first electronic device and a second electronic device to support user interface accessibility from a foldable portion of the first electronic device placed on a support surface adjacent to the second electronic device. The first electronic device has a foldable form factor that enables desktop placement in a partially unfolded position for handsfree viewing without the necessity of a holder or stand. However, in the partially unfolded position, only one portions of folding display of the first electronic device can be aligned with a display of the second electronic device. Presentation of display content and use of the at least one pointing input control for a single user input control (“instant control”) across both the first and the second electronic devices control is similar to mobile devices having a flat display that may be wholly aligned with the display of the second electronic device. The present disclosure additionally provides presentation and control solutions for addressing the first electronic device being in the partially unfolded position that makes an upper portion viewable and a lower power difficult to view.

In one or more embodiments, the first electronic device has a folding display including a first portion positioned on an inward side of the first housing and a second portion positioned on an inward side of the second housing. The first electronic device includes a communications subsystem. A controller of the first electronic device is communicatively coupled to the folding display and the communications subsystem. The controller configures the first electronic device to connect, via the communications subsystem, to the second electronic device. The controller configures the first electronic device to present a first logical display portion on the first portion of the folding display and a second logical display portion on the second portion of the folding display. In response at least in part on the first housing being in an angled position (i.e., partially unfolded) to the second housing, the controller configures the first electronic device to present the second logical display portion on a display of the second electronic device.

In one or more embodiments, by automatically allowing a single input control device to be used to control input for two electronic devices when the displays of the two electronic devices are partially spatially aligned, the techniques discussed herein improve the user interface of the one or more electronic devices by automatically enabling single input control in situations in which the user is likely to want to use a single input control device. For example, if the user has two electronic devices connected to one another and positioned next to one another on a table facing the user, it is expected that the user will want to use a single input control device to interact with the two electronic devices so a single input control device is automatically allowed to be used to control input for two electronic devices. This expectation extends to when one of the two devices has a foldable form factor and is placed on the desk in an angled or partially unfolded position with only an upper portion of a folding display aligned with the display of the second device.

In the following detailed description of exemplary embodiments of the disclosure, specific exemplary embodiments in which the various aspects of the disclosure may be practiced are described in sufficient detail to enable those skilled in the art to practice the invention, and it is to be understood that other embodiments may be utilized and that logical, architectural, programmatic, mechanical, electrical, and other changes may be made without departing from the spirit or scope of the present disclosure. The following detailed description is, therefore, not to be taken in a limiting sense, and the scope of the present disclosure is defined by the appended claims and equivalents thereof. Within the descriptions of the different views of the figures, similar elements can be provided with similar names and reference numerals as those of the previous figure(s). The specific numerals assigned to the elements are provided solely to aid in the description and are not meant to imply any limitations (structural or functional or otherwise) on the described embodiment. It will be appreciated that for simplicity and clarity of illustration, elements illustrated in the figures have not necessarily been drawn to scale. For example, the dimensions of some of the elements are exaggerated relative to other elements.

It is understood that the use of specific component, device and/or parameter names, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be given its broadest interpretation given the context in which that term is utilized.

As further described below, implementation of the functional features of the disclosure described herein is provided within processing devices and/or structures and can involve use of a combination of hardware, firmware, as well as several software-level constructs (e.g., program code and/or program instructions and/or pseudo-code) that execute to provide a specific utility for the device or a specific functional logic. The presented figures illustrate both hardware components and software and/or logic components.

Those of ordinary skill in the art will appreciate that the hardware components and basic configurations depicted in the figures may vary. The illustrative components are not intended to be exhaustive, but rather are representative to highlight essential components that are utilized to implement aspects of the described embodiments. For example, other devices/components may be used in addition to or in place of the hardware and/or firmware depicted. The depicted example is not meant to imply architectural or other limitations with respect to the presently described embodiments and/or the general invention. The description of the illustrative embodiments can be read in conjunction with the accompanying figures. Embodiments incorporating teachings of the present disclosure are shown and described with respect to the figures presented herein.

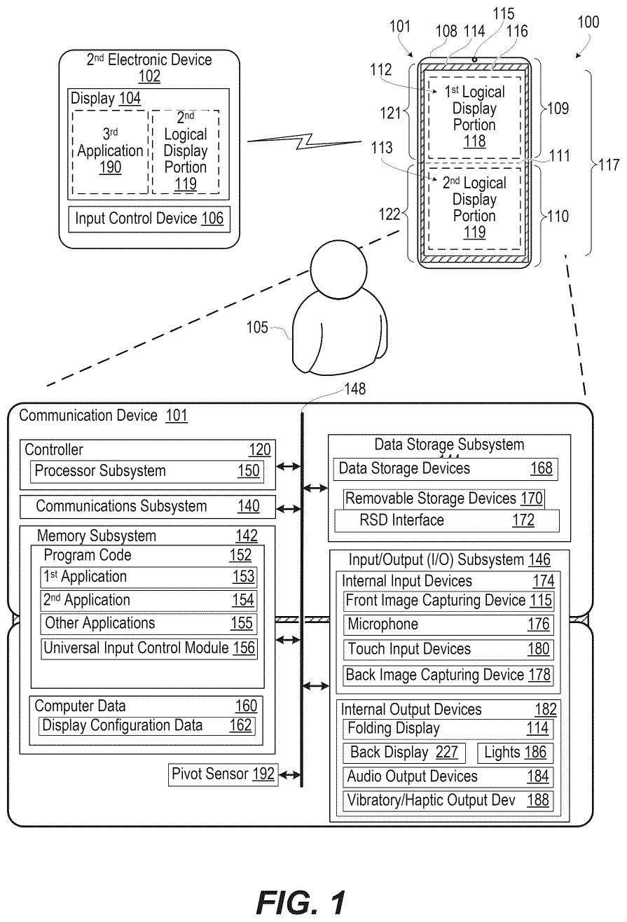

FIG. 1 presents a simplified functional block diagram of an electronic device in which the features of the present disclosure are advantageously implemented for single control input in a partially unfolded (“angled”) position in cooperation with connected display devices. In one or more embodiments, the electronic device includes additional communications functionality that enables electronic device to be referred to as communication device 101, which operates as a mobile user device in communication environment 100. Communication environment 100 includes at least one second electronic device 102 to which communication device 101 can communicatively couple and share interfaces and functions. In an example, second communication device 102 includes display 104 (e.g., laptop display or monitor) viewable by user 105. In one or more embodiments, second communication device 102 includes or is communicatively coupled to input control device 106 that user 105 may manipulate or interact with as a single user input control device for communication device 101 and second electronic device 102. In an example, input control device 106 may be a pointing device such as a computer mouse or eye gaze direction detector.

Communication device 101 can be one of a host of different types of devices, including but not limited to, a mobile cellular phone, satellite phone, or smart phone, a laptop, a netbook, an ultra-book, a networked smartwatch, or networked sports/exercise watch, and/or a tablet computing device or similar device that can include wireless communication functionality. As a device supporting wireless communication, communication device 101 can be utilized as, and also be referred to as, a system, device, subscriber unit, subscriber station, mobile station (MS), mobile, mobile device, remote station, remote terminal, user terminal, terminal, user agent, user device, a session initiation protocol (SIP) phone, a wireless local loop (WLL) station, a personal digital assistant (PDA), computer workstation, a handheld device having wireless connection capability, a computing device, or other processing devices. Second electronic device 102 may also be one of the host of different types of devices described above.

In one or more embodiments, communication device 101 (i.e., “a first electronic device”) includes foldable housing 108 that has a foldable form factor provided by first housing 109, second housing 110, and hinge 111 coupling first housing 109 to second housing 110. In FIG. 1, communication device 101 is in a fully unfolded position with folding display 114 extended across front inner sides 112-113 respectively of first and second housings 109-110. Front image capturing device 115 is positioned on first housing 109. Communication device 101 prepares logical display 116 of graphical content that is sized and assigned for presentation on folding display 114. Logical display 117 contains display information that has to be rendered and adjusted for display hardware that drives physical pixels of folding display 114. For displays that change size or availability, communication device 101 may alter presentation and assignment of portions of logical display 117 depending on pivot position of foldable housing 108. In an example, logical display 117 may be separated into first and second logical display portions 118-119 that correspond, and are assigned for presentation by controller 120, to first and second portions 121-122 of folding display 114.

In addition to, controller 120, communication device 101 may include communications subsystem 140, memory subsystem 142, data storage subsystem 144 and input/output (I/O) subsystem 146. To enable management by controller 120, system interlink 148 communicatively connects controller 120 with communications subsystem 140, memory subsystem 142, data storage subsystem 144 and I/O subsystem 146. System interlink 148 represents internal components that facilitate internal communication by way of one or more shared or dedicated internal communication links, such as internal serial or parallel buses. As utilized herein, the term “communicatively coupled” means that information signals are transmissible through various interconnections, including wired and/or wireless links, between the components. The interconnections between the components can be direct interconnections that include conductive transmission media or may be indirect interconnections that include one or more intermediate electrical components. Although certain direct interconnections (i.e., system interlink 148) arc illustrated in FIG. 1, it is to be understood that more, fewer, or different interconnections may be present in other embodiments.

Controller 120 includes processor subsystem 150, which includes one or more central processing units (CPUs) or data processors. Processor subsystem 150 can include one or more digital signal processors that can be integrated with data processor(s). Processor subsystem 150 can include other processors such as auxiliary processor(s) that may act as a low power consumption, always-on sensor hub for physical sensors. Controller 120 manages, and in some instances directly controls, the various functions and/or operations of communication device 101. These functions and/or operations include, but are not limited to including, application data processing, communication, navigation tasks, image processing, and signal processing. In one or more alternate embodiments, communication device 101 may use hardware component equivalents for application data processing and signal processing. For example, communication device 101 may use special purpose hardware, dedicated processors, general purpose computers, microprocessor-based computers, micro-controllers, optical computers, analog computers, dedicated processors and/or dedicated hard-wired logic.

Memory subsystem 142 stores program code 152 for execution by processor subsystem 150 to provide the functionality described herein. Program code 152 includes applications such as first application 153, second application 154, and other applications 155 that generate portions of logical display 117. Universal input control module 156 enables cooperative control between communication device 101 and second electronic device 102. When communication device 101 communicatively couples to second electronic device 102, activation of universal input control modules 156 at respective devices 101-102 are triggered. Upon detecting availability of cooperative “instant control” by establishing communication between universal input control modules 156, each device 101-102 identifies to the other device 101-102 input control devices (106) available to act as a single input control for both devices 101-102. When one of the identified input control devices is actuated by user 105, the corresponding devices 101-102 that includes the input control device determines whether the input control device is directed to a display (104 or 114) corresponding to the other device 101-102. In response to determining direction of user input to the display (104 or 114) corresponding to the other devices 101-102, the corresponding device 101-102 communicates the user input to the other devices 101-102. The other device 101-102 receiving the user input responds in a similar manner as if the user input had originated from an input control device managed by the other devices 101-102. According to aspects of the present disclosure, single input control module 156 enhances control capabilities by providing single input control even for partially unfolded devices such as communication device 101. These applications/modules may be software or firmware that, when executed by controller 120, configures communication device 101 to provide functionality described herein.

In one or more embodiments, several of the described aspects of the present disclosure are provided via executable program code of applications executed by controller 120. In one or more embodiments, program code 152 may be integrated into a distinct chipset or hardware module as firmware that operates separately from executable program code. Portions of program code 152 may be incorporated into different hardware components that operate in a distributed or collaborative manner. Memory subsystem 142 further includes operating system (OS), firmware interface, such as basic input/output system (BIOS) or Uniform Extensible Firmware Interface (UEFI), and firmware, which also includes and may thus be considered as program code 152.

Program code 152 may access, use, generate, modify, store, or communicate computer data 160, such as display configuration data 162 that supports, and is updated by, universal input control module 156. Computer data 160 may incorporate “data” that originated as raw, real-world “analog” information that consists of basic facts and figures. Computer data 160 includes different forms of data, such as numerical data, images, coding, notes, and financial data. Computer data 160 may originate at communication device 101 or be retrieved from a remote device via communications subsystem 140. Communication device 101 may store, modify, present, or transmit computer data 160 such as sound profile data 162. Computer data 160 may be organized in one of a number of different data structures. Common examples of computer data 160 include video, graphics, text, and images. Computer data 160 can also be in other forms of flat files, databases, and other data structures.

Data storage subsystem 144 of communication device 101 includes data storage device(s) 168. Controller 120 is communicatively connected, via system interlink 148, to data storage device(s) 168. Data storage subsystem 144 provides program code 152 and computer data 160 stored on nonvolatile storage that is accessible by controller 120. For example, data storage subsystem 144 can provide a selection of program code 152 and computer data 160. These applications can be loaded into memory subsystem 142 for execution/processing by controller 120. In one or more embodiments, data storage device(s) 168 can include hard disk drives (HDDs), optical disk drives, and/or solid-state drives (SSDs), etc. Data storage subsystem 144 of communication device 101 can include removable storage device(s) (RSD(s)) 170, which is received in RSD interface 172. Controller 120 is communicatively connected to RSD 170, via system interlink 148 and RSD interface 172. In one or more embodiments, RSD 170 is a non-transitory computer program product or computer readable storage device that may be executed by a processor associated with a user device such as communication device 101. Controller 120 can access data storage device(s) 168 or RSD 170 to provision communication device 101 with program code 152 and computer data 160.

I/O subsystem 146 may include internal input devices 174 such as microphone 176, front and back image capturing device(s) 115 and 178, and touch input devices 180 (e.g., screens, keys, or buttons). I/O subsystem 146 may include internal output devices 182 such as folding display 114, audio output devices 184, lights 186, vibratory or haptic output devices 188, and back display 227. Internal input devices 182 may also include sensors such as pivot sensor 192 that detects and reports to processor one or more states of foldable housing 108, from among: (i) fully folded, (ii) partially unfolded; and (iii) fully unfolded. Pivot sensor 192 may detect one or more discrete values or a continuous range of values corresponding to different angles between first and second housings 109-110.

In one or more embodiments, controller 120, via communications subsystem 140, performs multiple types of cellular over-the-air (OTA) or wireless communication, such as by using a Bluetooth connection or other personal access network (PAN) connection. In an example, a user may wear a health monitoring device such as a smartwatch that is communicatively coupled via a wireless connection. In one or more embodiments, communications subsystem 140 includes a global positioning system (GPS) module that receives GPS broadcasts from GPS satellites to obtain geospatial location information. In one or more embodiments, controller 120, via communications subsystem 140, communicates via a wireless local area network (WLAN) link using one or more IEEE 802.11 WLAN protocols with an access point. In one or more embodiments, controller 120, via communications subsystem 140, may communicate via an OTA cellular connection with radio access networks (RANs). In an example, communication device 101, via communications subsystem 140, connects via RANs of a terrestrial network that is communicatively connected to a network server.

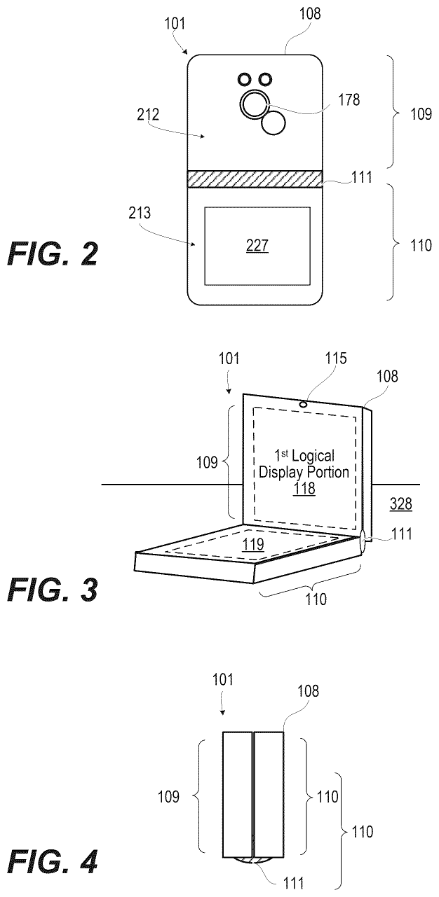

FIG. 2 is a back view of communication device 101 having foldable housing 108 in a fully unfolded position. Back sides 212-213 of first and second housings 109-110 respectively provide back image capturing devices 178 and back display 227 that is always exposed independent of pivoting of foldable housing 108. FIG. 3 is a three-dimensional view of communication device 101 having second housing 110 placed on and aligned with support surface 328 (e.g., table or desk) with foldable housing 108 partially unfolded to present first housing 109 generally upward in an angled position. The partially unfolded or angled position may also be referred to as a “laptop” position appearing similarly to the way laptops are typically positioned for use. FIG. 4 is a side view of communication device 101 having first and second housings 109-110 fully folded, pivoted together, hiding folding display 114 (FIG. 1), and configuring communication device 101 in a more compact form for portability and stowage. One or more aspects of the disclosure are particularly applicable to communication device 101 when configured in the angled position presented by FIG. 3.

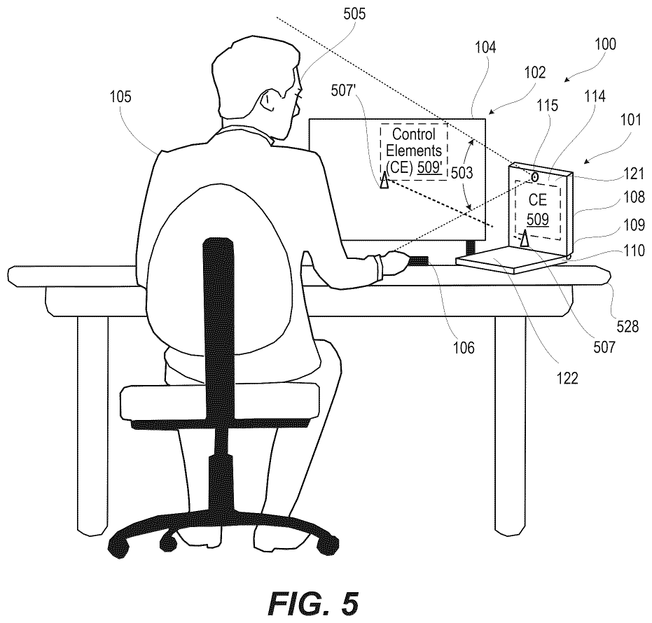

FIG. 5 is a three-dimensional view of communication device 101 in the partially unfolded, angled position placed on support surface 528 in partial alignment with display 104 of second electronic device 102. Front image capturing device 115 has front field of view (FOV) 503 that may be used to detect when any human face, or an individually recognized facc 505 of authorized user 105 is positioned in front of folding display 114. In one embodiment, the presence of a human face while the device is in partially unfolded state (as detected by position or pivot sensor 192 (FIG. 1)) serves, in part as confirmation of partial alignment of the first portion 121 of folding display 114 of communication device 101 with the display 104 of second electronic device 102, which triggers/enables the described functionality, according to the present disclosure. Instant control is enabled when communication device 101 is communicatively coupled to second electronic device 102. Input control device 106 (e.g., mouse or track pad) of second electronic device 102 may be used for instant of cursor 507 to interact with control elements 509 (e.g., radio buttons, toggle buttons, sliders, pulldown menus, etc.) presented on folding display 114 of communication device 101. Repositioned cursor 507′ on display 104 of second electronic device 102 can interact with duplicated control elements 509′. In one or more embodiments, controller 120 configures communication device 101 to receive, while universal input control (i.e., instant control) is enabled, an indication of user input received by second electronic device 102 via input control device 106 connected to second electronic device 102 directed to a first content portion of second logical display portion 119, such as either control elements 509 on folding display 114 or duplicated control elements 509′ on display 104). Controller 120 configures communication device 101 to perform an action corresponding to the user input and affecting an application associated with the first content portion of control elements 509 and 509′.

With this embodiment, user 105 positioned in front of display 104 of second electronic device 102 and first portion 121 of folding display 114 on first housing 109 of foldable housing 108 is also presented with the content of the “hidden” or “flattened” display (second portion 122 of folding display 114) on second housing 110 of foldable housing 108. The skewed position of user 105 in relation to second portion 122 of folding display 114 may exceed a viewing angle the visual content (i.e., second logical display portion 119) at which folding display 114 can be viewed with an acceptable visual performance. The viewing angle may be defined in an angular range as a viewing cone. The visual content or image may seem garbled, poorly saturated, of poor contrast, blurry, or too faint outside the stated viewing angle range. The exact mode of “failure” depends on the display type of folding display 114. For example, some projection screens reflect more light perpendicular to the screen and less light to the sides, making the screen appear much darker (and sometimes colors distorted) if the viewer is not in front of the screen. For other display technologies viewable from a wider viewing angle, the “failure” may be wholly based on the angular skewed presentation, compressing the visual content or image.

According to aspects of the present disclosure, with reference to FIG. 1, controller 120 configures communication device 101 to connect, via communications subsystem 140, to second electronic device 102 that may be independently executing and presenting one or more third applications 190. Controller 120 configures communication device 101 to present first logical display portion 118 on first portion 121 of folding display 114 and second logical display portion 119 on second portion 122 of folding display 114. In response, at least in part, to first housing 109 being in an angled position to second housing 110, controller 120 configures communication device 101 to present second logical display portion 119 on display 104 of second electronic device 102, which user 105 is positioned to view. By contrast, with particular reference to FIG. 5, user 105 is in a skewed position (i.e., non-orthogonal) from the “hidden” or “flattened” display (second portion 122 of folding display 114) on second housing 110 of foldable housing 108.

In one or more embodiments, with reference to FIG. 1, controller 120 configures communication device 101 to detect folding display 114 being in the angled position based on position or movement input from pivot sensor 192, which is communicatively coupled to controller 120. In one or more particular embodiments, controller 120 configures communication device 101 to present second logical display portion 119 on display 104 of second electronic device 102 based at least in part on identifying, in an image captured by front image capturing device 115, face 505 (FIG. 5) of user 105 viewing first portion 121 of folding display 114.

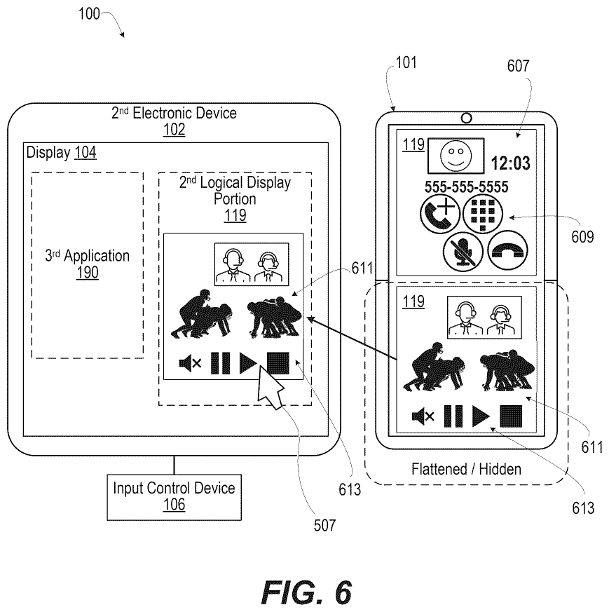

In an example, first and second logical display portions 118-119 may be generated by different applications that respectively provide functionality such as on device control, messaging, personal productivity, communication, media presentation, etc. FIG. 6 is a front view of communication environment 100 of communication device 101 presenting content from two applications with duplication of hidden or flattened content duplicated on display 104 of second electronic device 102. In an example, first logical display portion 118 is provided by first application 153 (FIG. 1) that is a voice communication application and is presented on first portion 121 of folding display 114. User 105 (FIG. 5) is positioned to view first logical display portion 118, which includes informational content 607 and communication controls 609. Second logical display portion 119 is provided by second application 154 (FIG. 1) that is a media player application and is presented on second portion 122 of folding display 114. User 105 (FIG. 5) is not positioned to view second logical display portion 119, which includes informational content 611 and media player controls 613. Communication device 101 also presents second logical display portion 119 on display 104 of second electronic device 102, which user 105 (FIG. 5) is positioned to view. In addition to successfully viewing informational content 611, user 105 (FIG. 5) may more successfully use input control device 106 to position cursor 507 on media player controls 613 duplicated on display 104 of second electronic device 102 than on folding display 114 of communication device 101.

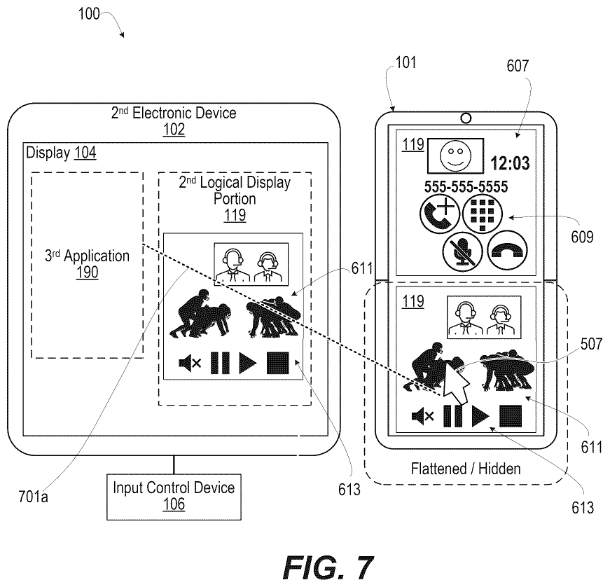

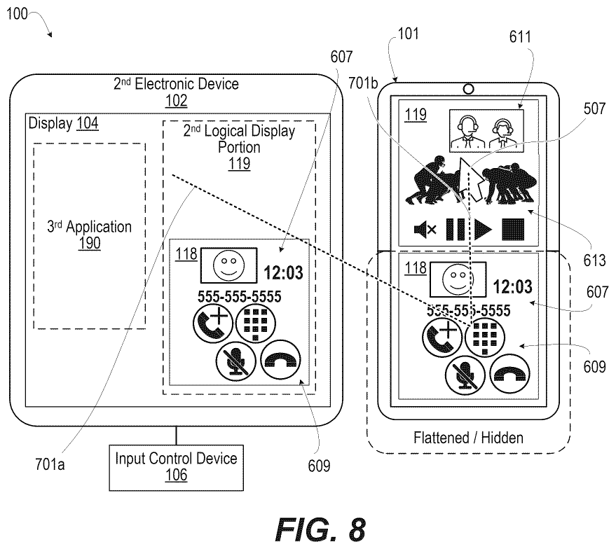

FIG. 7 is the front view of communications environment 100 of FIG. 6 with instant control track 701a moving cursor 507 onto second portion 122 of folding display 114 that user 105 (FIG. 5) is not positioned to view. FIG. 8 is the front view of communications environment 100 of FIG. 7 with communication device swapping first and second logical display portions 118-119 in response to the instant control track 701a moving cursor 507 onto second portion 122 of folding display 114. Instant control track 701b may then move cursor 507 onto first portion 121 of folding display 114. User 105 (FIG. 5) is positioned to view and to interact with repositioned second logical display portion 119 at first portion 121 of folding display 114. In one or more embodiments, controller 120 (FIG. 1) configures communication device 101 to, in response to receiving, from the second electronic device via the communications subsystem 140 (FIG. 1), a pointer input (e.g., cursor 507) directed to second portion 122 of folding display 114, configures communication device 101 to present second logical display portion 119 on first portion 121 of folding display 114. Controller 120 configures communication device 101 to present first logical display portion 118 on second portion 122 of folding display 114. In one or more particular embodiments, controller 120 configures communication device 101 to also present duplicated first logical display portion 118′ on display 104 of second electronic device 102. First logical display portion 118 is now not readily visible on second portion 122 of folding display 114.

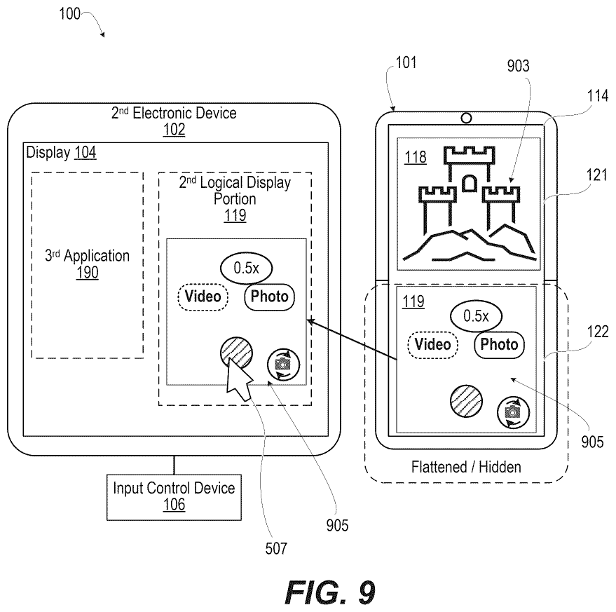

In another example, first and second logical display portions 118-119 may be generated by the same application, presenting two complementary aspects of the same activity, such as media presentation and controls for the media presentation. FIG. 9 is a front view of communication environment 100 of communication device 101 presenting content from one first application 153 (FIG. 1) such as a camera application with duplication of hidden or flattened content duplicated on display 104 of second electronic device 102. Keeping the camera preview 903 on a viewable portion (i.e., first portion 121 of folding display 114) may be more intuitive to the user who may use front or back image capturing device 115 and 178 of communication device 101 when not communicatively coupled to second electronic device 102. In one or more embodiments, controller 120 configures communication device 101 to assign first user interface (UI) features such as camera preview 903 of first application 153 (FIG. 1) as first logical display portion 118 presented within first portion 121 of folding display 114. Controller 120 configures communication device 101 to assign second UI features such as camera controls 905 of second application 154 as second logical display portion 119 presented within second portion 122 of folding display 114. User 105 (FIG. 5) may more successfully use input control device 106 to position cursor 507 on camera controls 905 duplicated on display 104 of second electronic device 102 than on folding display 114 of communication device 101.

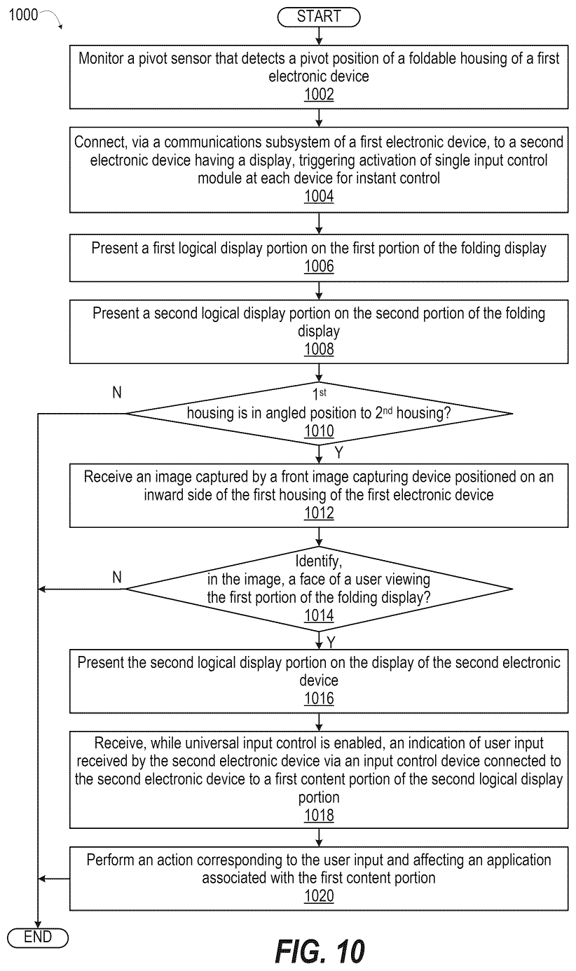

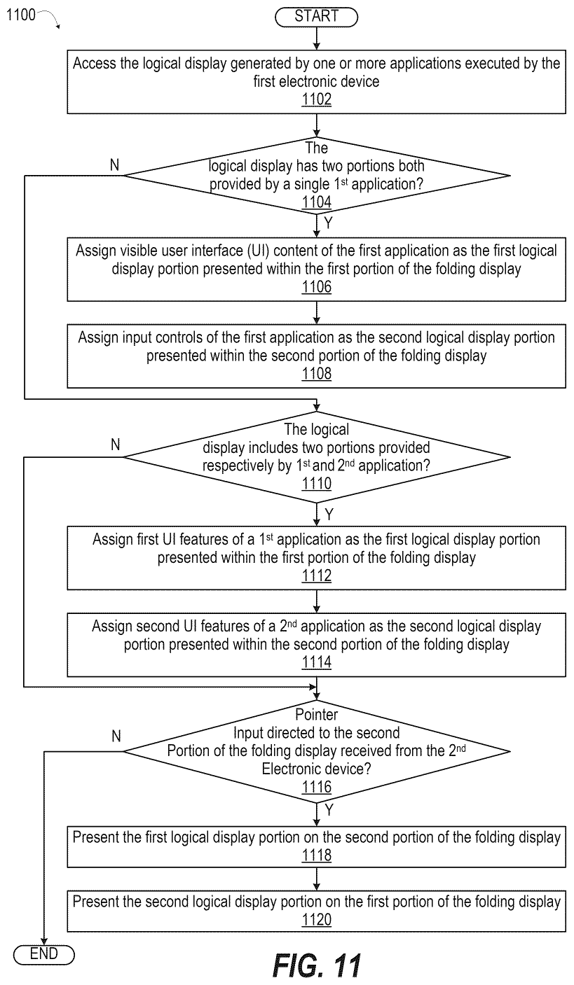

FIG. 10 is a flow diagram presenting method 1000 of providing a cooperative user interface connection between the first electronic device and a second electronic device to support user interface accessibility from a foldable portion of the first electronic device placed on a support surface adjacent to the second electronic device. FIG. 11 is a flow diagram presenting method 1100, augmenting method 1000 (FIG. 10), of special use cases for assigning particular portions of a logical display. The descriptions of method 1000 (FIG. 10) and method 1100 (FIG. 11) arc provided with general reference to the specific components illustrated within the preceding FIGS. 1-9. Specific components referenced in 1000 (FIG. 10) and method 1100 (FIG. 11) may be identical or similar to components of the same name used in describing preceding FIGS. 1-9. In one or more embodiments, controller 120 (FIG. 1) configures communication device 101 (FIG. 1) or a similar computing device to provide the described functionality of method 1000 (FIG. 10) and method 1100 (FIG. 11).

With reference to FIG. 10, method 1000 includes monitoring, by a processor/controller of a first electronic device, a pivot sensor that detects a pivot position of a foldable housing of the first electronic device (block 1002). In one or more embodiments, the foldable housing includes a first housing, a second housing, and a hinge coupling the first housing to the second housing. The first housing is pivotable about the hinge relative to the second housing between a folded closed position and an unfolded open position. The foldable housing is configured for angled positioning on a support surface with the second housing positioned on and aligned with the support surface and the first housing being oriented away from the support surface. Method 1000 includes connecting, via a communications subsystem of the first electronic device, to a second electronic device having a display, triggering activation of single input control module at each device for instant control (block 1004). The first electronic device has a folding display including a first portion positioned on an inward side of the first housing and a second portion positioned on an inward side of the second housing. The folding display may be single flexible display. Alternatively, the folding display may be two or more displays with the hinge being positioned between two displays. Method 1000 includes presenting a first logical display portion on the first portion of the folding display (block 1006). Method 1000 includes presenting a second logical display portion on the second portion of the folding display (block 1008). Method 1000 includes determining whether the first housing is in angled position to the second housing (decision block 1010). In response to determining that the first housing is not in angled position to the second housing, method 1000 ends. The processor then continues monitoring for the pivot sensor to indicate that the first electronic device is configured with the first housing in the angled position relative to the second housing.

In response to determining that the first housing is in an angled position to the second housing, in one or more embodiments, method 1000 includes triggering a front image capturing device positioned on an inward side of the first housing to activate and capture a preview image of a field of view of the front image capturing device (block 1012). Method includes analyzing the captured preview image and determining whether a face of a user viewing the first portion of the folding display is identified in the image (decision block 1014). In an example, image recognition (e.g., via an AI module) identifies a human face that is positioned to be able to view the first portion of the folding display. The user may be currently gazing at the display of the second electronic device but may change the direction of gaze to view the folding display. In response to determining that there is no face of a user identified viewing the first portion of the folding display, method 1000 ends. In response to determining that a face of a user viewing the first portion of the folding display is identified, method 1000 includes configuring the processor of the second electronic device to render a mirror image of the second logic display portion and modify the display of the second electronic device to present the second logical display portion on the display of the second electronic device (block 1016). In one or more embodiments, the configuring can be achieved by transmitting to the second electronic device, via the established sharing medium between the two devices, image sharing data including rendering data and metadata corresponding to the second logical display portion to the second electronic device. Method 1000 includes receiving, while universal input control is enabled, an indication of user input received by the second electronic device via an input control device connected to the second electronic device to a first content portion of the second logical display portion (block 1018). Method 1000 includes performing an action corresponding to the user input and modifying one or more features associated with an application associated with the first content portion (block 1020). Then method 1000 ends.

With reference to FIG. 11, method 1100 includes accessing the logical display generated by one or more applications executed by the first electronic device (block 1102). Method 1100 includes determining whether the logical display has two portions both provided by a single first application, including a video portion and a user input control portion (decision block 1104). In response to determining that the logical display has the two portions respectively provided by the single first application, method 1100 includes assigning visible user interface (UI) content of the first application as the first logical display portion presented within the first portion of the folding display (block 1106). Method 1100 includes assigning input controls of the first application as the second logical display portion presented within the second portion of the folding display (block 1108).

In response to determining that the logical display does not have two portions by a single first application in decision block 1104, method 1100 includes determining whether the logical display includes two portions provided respectively by a first application and a second application (decision block 1110). In response to determining that the logical display includes two portions provided by the first application and the second application, method 1100 includes assigning first UI features of a first application as the first logical display portion presented within the first portion of the folding display (block 1112). Method 1100 includes assigning second UI features of a second application as the second logical display portion presented within the second portion of the folding display (block 1114).

In one or more embodiments, method 1100 includes duplicating the second logical display portion on the display of the second electronic display as described above with regard to method 1000 of FIG. 10. In one or more embodiments, method 1100 does not include duplicating the second logical display portion on the display of the second electronic display unless the instant control indicates a user input directed to the second portion of the folding display of the electronic device as described below in blocks block 1116 et seq. In one or more embodiments, method 1100 does not include duplicating the second logical display portion on the display of the second electronic display, relying instead on altering presentation of first and second logical display portions on the folding display of the electronic device as described below in blocks 1116 et seq.

After assigning the second UI features of the first application in block 1108 or of the second application in block 1114, method 1100 includes determining whether a pointer input directed to the second portion of the folding display is received from the second electronic device via the communications subsystem (decision block 1116). In response to determining that the pointer input is not received from the second electronic system that is directed to the second portion of the folding display, method 1100 ends. In response to determining that the pointer input directed to the second portion of the folding display is received from the second electronic system, method 1100 includes rendering and presenting the first logical display portion on the second portion of the folding display (block 1118). Method 1100 includes rendering and presenting the second logical display portion on the first portion of the folding display (block 1120). Then method 1100 ends.

Accordingly, aspects of the present disclosure provide enhancements to universal input control (“instant control”) to be applicable to combinations of connected devices that include an electronic device having a foldable housing positioned in a partially folded position (i.e., “laptop” position). Alignment of a portion of a folding display and availability of a cooperative instant control connection between devices enables features for both the viewable portion of the folding display and the hidden or less viewable portion of the folding display. Single input control interaction with control elements presented on the viewable first portion of the folding display and presented on the display of the second electronic device trigger an associated response to a corresponding application on a corresponding one of electronic display and the second electronic display as if originating by an input control device managed at the corresponding one of electronic display and the second electronic display. In one or more embodiments, control elements presented on the hidden or less viewable portion of the folding are duplicated on the display of the second electronic device that is viewable. Alternatively, or in addition, in response to a user input directed to control elements presented on the hidden or less viewable portion of the folding display, the control elements are moved to the viewable portion of the folding display to enable accurate interaction by the single input control.

Aspects of the present innovation are described above with reference to flowchart illustrations and/or block diagrams of methods, apparatus (systems) and computer program products according to embodiments of the innovation. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

As will be appreciated by one skilled in the art, embodiments of the present innovation may be embodied as a system, device, and/or method. Accordingly, embodiments of the present innovation may take the form of an entirely hardware embodiment or an embodiment combining software and hardware embodiments that may all generally be referred to herein as a “circuit,” “module” or “system.”

While the innovation has been described with reference to exemplary embodiments, it will be understood by those skilled in the art that various changes may be made, and equivalents may be substituted for elements thereof without departing from the scope of the innovation. In addition, many modifications may be made to adapt a particular system, device, or component thereof to the teachings of the innovation without departing from the essential scope thereof. Therefore, it is intended that the innovation not be limited to the particular embodiments disclosed for carrying out this innovation, but that the innovation will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the innovation. As used herein, the singular forms “a”, “an” and “the” are intended to include the plural forms as well, unless the context clearly indicates otherwise. It will be further understood that the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present innovation has been presented for purposes of illustration and description but is not intended to be exhaustive or limited to the innovation in the form disclosed. Many modifications and variations will be apparent to those of ordinary skill in the art without departing from the scope and spirit of the innovation. The embodiments were chosen and described in order to best explain the principles of the innovation and the practical application, and to enable others of ordinary skill in the art to understand the innovation for various embodiments with various modifications as are suited to the particular use contemplated.

1. A first electronic device, comprising:
a foldable housing comprising a first housing, a second housing, and a hinge coupling the first housing to the second housing, the first housing pivotable about the hinge relative to the second housing between a folded closed position and an unfolded open position, the foldable housing configured for angled positioning on a support surface, the angled position comprising the second housing positioned on and aligned with the support surface and the first housing oriented away from the support surface;
a folding display comprising a first portion positioned on an inward side of the first housing and a second portion positioned on an inward side of the second housing;
a communications subsystem; and
a controller communicatively coupled to the folding display and the communications subsystem, and which configures the first electronic device to:
connect, via the communications subsystem, to a second electronic device;
present a first logical display portion on the first portion of the folding display and a second logical display portion on the second portion of the folding display; and
in response at least in part on the first housing being in an angled position to the second housing, present the second logical display portion on a display of the second electronic device.

2. The first electronic device of claim 1, wherein the controller configures the first electronic device to:
assign visible user interface (UI) content of a first application as the first logical display portion presented within the first portion of the folding display; and
assign input controls of the first application as the second logical display portion presented within the second portion of the folding display.

3. The first electronic device of claim 1, wherein the controller configures the first electronic device to:
assign first user interface (UI) features of a first application as the first logical display portion presented within the first portion of the folding display; and
assign second UI features of a second application as the second logical display portion presented within the second portion of the folding display.

4. The first electronic device of claim 1, wherein the controller configures the first electronic device to:
in response to receiving, from the second electronic device via the communications subsystem, a pointer input directed to the second portion of the folding display:
present the second logical display portion on the first portion of the folding display; and
present the first logical display portion on the second portion of the folding display.

5. The first electronic device of claim 1, wherein the controller configures the first electronic device to:
receive, while universal input control is enabled, an indication of user input received by the second electronic device via an input control device connected to the second electronic device directed to a first content portion of the second logical display portion; and
perform an action corresponding to the user input and affecting an application associated with the first content portion.

6. The first electronic device of claim 1, further comprising a pivot sensor communicatively coupled to the controller wherein the controller configures the first electronic device to detect the folding display being in the angled position based on position or movement input from the pivot sensor.

7. The first electronic device of claim 6, further comprising a front image capturing device positioned on an inward side of the first housing of the first electronic device and communicatively coupled to the controller, wherein the controller configures the first electronic device to:
trigger the front image capturing device to capture an image;
identify, in the image captured by the front image capturing device, a face of a user viewing the first portion of the folding display; and
present the second logical display portion on the display of the second electronic device based at least in part on identifying the face of a user viewing the first portion of the folding display.

8. A method, comprising:
monitoring a pivot position of a foldable housing of a first electronic device, the foldable housing comprising a first housing, a second housing, and a hinge coupling the first housing to the second housing, the first housing pivotable about the hinge relative to the second housing between a folded closed position and an unfolded open position, the foldable housing configured for angled positioning on a support surface, the angled position comprising the second housing positioned on and aligned with the support surface and the first housing oriented away from the support surface;
connecting, via a communications subsystem of the first electronic device, to a second electronic device having a display, the first electronic device having a folding display comprising a first portion positioned on an inward side of the first housing and a second portion positioned on an inward side of the second housing;
presenting a first logical display portion on the first portion of the folding display and a second logical display portion on the second portion of the folding display; and
in response at least in part on the first housing being in an angled position to the second housing, presenting the second logical display portion on the display of the second electronic device.

9. The method of claim 8, further comprising:
assigning visible user interface (UI) content of a first application as the first logical display portion presented within the first portion of the folding display; and
assigning input controls of the first application as the second logical display portion presented within the second portion of the folding display.

10. The method of claim 8, further comprises:
assigning first user interface (UI) features of a first application as the first logical display portion presented within the first portion of the folding display; and
assigning second UI features of a second application as the second logical display portion presented within the second portion of the folding display.

11. The method of claim 8, further comprising:
in response to receiving, from the second electronic device via the communications subsystem, a pointer input directed to the second portion of the folding display:
presenting the second logical display portion on the first portion of the folding display; and
presenting the first logical display portion on the second portion of the folding display.

12. The method of claim 8, further comprising:
receiving, while universal input control is enabled, an indication of user input received by the second electronic device via an input control device connected to the second electronic device to a first content portion of the second logical display portion; and
performing an action corresponding to the user input and affecting an application associated with the first content portion.

13. The method of claim 8, further comprising detecting the folding display being in the angled position based on position or movement input from a pivot sensor of the first electronic device.

14. The method of claim 13, further comprising presenting the second logical display portion on the display of the second electronic device based at least in part on:
triggering a front image capturing device to capture an image; and
identifying, in the image captured by the front image capturing device positioned on an inward side of the first housing of the first electronic device, a face of a user viewing the first portion of the folding display.

15. A computer program product comprising:
a non-transitory computer readable storage device; and
program code on the computer readable storage device that when executed by a processor associated with a first electronic device, the program code configures the first electronic device to provide functionality of:
monitoring a pivot position of a foldable housing of a first electronic device, the foldable housing comprising a first housing, a second housing; and a hinge coupling the first housing to the second housing, the first housing pivotable about the hinge relative to the second housing between a folded closed position and an unfolded open position, the foldable housing configured for angled positioning on a support surface, with the angled position comprising the second housing positioned on and aligned with the support surface and the first housing oriented away from the support surface;
connecting, via a communications subsystem of a first electronic device, to a second electronic device having a display, the first electronic device having a folding display comprising a first portion positioned on an inward side of the first housing and a second portion positioned on an inward side of the second housing;
presenting a first logical display portion on the first portion of the folding display and a second logical display portion on the second portion of the folding display; and
in response at least the first housing being in the angled position to the second housing, presenting the second logical display portion on the display of the second electronic device.

16. The computer program product of claim 15, wherein the program code configures the first electronic device to provide functionality of:
assigning visible user interface (UI) content of a first application as the first logical display portion presented within the first portion of the folding display; and
assigning input controls of the first application as the second logical display portion presented within the second portion of the folding display.

17. The computer program product of claim 15, wherein the program code configures the first electronic device to provide functionality of:
assigning first user interface (UI) features of a first application as the first logical display portion presented within the first portion of the folding display; and
assigning second UI features of a second application as the second logical display portion presented within the second portion of the folding display.

18. The computer program product of claim 15, wherein the program code configures the first electronic device to provide functionality of:
in response to receiving, from the second electronic device via the communications subsystem, a pointer input directed to the second portion of the folding display:
presenting the second logical display portion on the first portion of the folding display; and
presenting the first logical display portion on the second portion of the folding display.

19. The computer program product of claim 15, wherein the program code configures the first electronic device to provide functionality of:
receiving, while universal input control is enabled, an indication of user input received by the second electronic device via an input control device connected to the second electronic device to a first content portion of the second logical display portion; and
performing an action corresponding to the user input and affecting an application associated with the first content portion.

20. The computer program product of claim 15, wherein the program code configures the first electronic device to provide functionality of:
detecting the folding display being in the angled position based on position or movement input from a pivot sensor of the first electronic device; and
presenting the second logical display portion on the display of the second electronic device based at least in part on identifying, in an image captured by a front image capturing device positioned on an inward side of the first housing of the first electronic device, a face of a user viewing the first portion of the folding display.
